(19) United States
(12) Patent Application Publication
(10) Pub. No.: US 2006/0041510 A1
(43) Pub. Date: Feb. 23, 2006

(54) Method for a secure system of content distribution for DVD applications

(75) Inventors: Gregory J. Gagnon, Redondo Beach, CA (US); Ronald P. Cocchi, Seal Beach, CA (US); Dennis R. Flaharty, Irvine, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: SecureMedia International

(21) Appl. No.: 11/196,053

(22) Filed: Aug. 3, 2005

Related U.S. Application Data
(60) Provisional application No. 60/602,621, filed on Aug. 19, 2004.

(51) Int. Cl. G06Q 99/00

(52) U.S. Cl. 705/51

(57) ABSTRACT

Methods and apparatuses for increasing the security of video content in a limited distribution environment. A system in accordance with the present invention comprises an encrypted media carrier, encrypted using a first encryption key, and a media player, designed to receive the encrypted media carrier, the media player comprising a first decryption key stored in an decryption chip, wherein the first encryption key and the first decryption key are serialized, and the decryption key is entered into the media player at a component level, and the first encryption key is stored at a secure storage facility.

### CROSS-REFERENCE TO RELATED APPLICATIONS

This application claims the benefit under 35 U.S.C. Section 119(e) of the following co-pending and commonly-assigned U.S. provisional patent application, which is incorporated by reference herein:

Provisional Application Ser. No. 60/602,621, filed Aug. 19, 2004, by Gregory J. Gagnon et al, entitled “METHOD FOR A SECURE SYSTEM OF CONTENT DISTRIBUTION FOR DVD APPLICATIONS.”

### BACKGROUND OF THE INVENTION

1. Field of the Invention

The present invention relates generally to viewing of video programming, and in particular, to a method, apparatus, and article of manufacture for a secure system of content distribution for Digital Video Disc (DVD) applications.

2. Description of the Related Art

Electronics and software have become part of everyday life. Automobiles, Compact Disc (CD) players, computers, Personal Data Assistants (PDAs), personal and home-based game consoles, and many other consumer electronic devices have integrated software installed.

Many companies produce video programs, e.g., movies, and the production companies and other companies distribute these programs via several different distribution channels. For example, video rental stores have stores where people can come in and select desired programs in person, or people can select programs over Internet-based distribution schema.

Companies spend millions of dollars annually to prevent unauthorized copying of these programs through encryption, watermarking, and other hardware and software based devices. However, because of the standardized techniques used to manufacture the physical medium of delivery, i.e., the DVD disk itself, and the standardized playback mechanism, i.e., the DVD player, it is rather easy for pirates and other copyists to produce copies of the program that can play on any DVD player.

Even though anti-piracy efforts have increased in recent years, pirates can make enough profit in a short time, with minimal cost, to run the risk of litigation. The period of time from introduction of pirated goods to the market place to the time the pirated goods are noticed, to the time that the pirates are located, is enough time for the pirates to make enough money and avoid capture, even if they have to abandon the cloning of a particular product. Further, there is no way currently to determine the original source of a pirated DVD program, which would make it easier to disable the entire pirating scheme, rather than merely closing down the reproduction houses.

As such, it can be seen that there is a need in the art for a method to make it more difficult for the pirates to succeed in their piracy efforts. It can also be seen that there is a need in the art to be able to determine the original source of pirated programs.

### SUMMARY OF THE INVENTION

To minimize the limitations in the prior art, and to minimize other limitations that will become apparent upon reading and understanding the present specification, the present invention discloses methods and apparatuses for increasing the security of video content in a limited distribution environment. A system in accordance with the present invention comprises an encrypted media carrier, encrypted using a first encryption key, and a media player, designed to receive the encrypted media carrier, the media player comprising a first decryption key stored in an decryption chip, wherein the first encryption key and the first decryption key are serialized, and the decryption key is entered into the media player at a component level, and the first encryption key is stored at a secure storage facility.

The system optionally further comprises a second encryption key and a second decryption key, wherein the second encryption key is accessible outside of the secure storage facility, a watermark applied to the encrypted media carrier, the first decryption key being stored in the decryption chip during manufacturing, the first decryption key being accessible only within the decryption chip, a distribution list which is used to distribute the encrypted media carrier, the encrypted media carrier being distributed based on a location of the media player having the first decryption key, the secure storage facility being operated by a third party, and the media player decrypting a media carrier that was not encrypted using the first encryption key.

A method in accordance with the present invention comprises generating a plurality of pairs of mated serialized encryption keys and mated serialized decryption keys, embedding the mated serialized decryption keys into decryption chips on the component level, encrypting the video programming onto media carriers using the mated serialized encryption keys, and distributing the encrypted media carriers to users of the decryption chips, wherein the media carrier is sent to the user of the mated serialized decryption chip corresponding to the mated encryption chip used to encrypt the media carrier.

The method optionally further comprises the mated serialized encryption keys and mated serialized decryption keys being stored at a secure storage facility, generating a second pair of encryption keys and decryption keys, embedding the second decryption key into at least one decryption chip on the component level, and allowing access to the second encryption key outside of the secure storage facility, applying a watermark to the video programming on the encrypted media carrier, the mated decryption key being stored in the decryption chip during manufacturing, the mated decryption key being accessible only within the decryption chip, the decryption keys being cross-referenced to users on a distribution list which is used to distribute the media carriers, the secure storage facility being operated by a third party, and media carriers that are encrypted using the mated encryption key can be decrypted by the decryption chips.

### BRIEF DESCRIPTION OF THE DRAWINGS

Referring now to the drawings in which like reference numbers represent corresponding parts throughout:

FIG. 1 illustrates a typical DVD player block diagram;

FIG. 2 illustrates a block diagram of how an unserialized binary image is generated utilizing the present invention;

FIG. 3 illustrates the hardware security features of the present invention;

FIG. 4 illustrates a functional overview of a chip designed in accordance with the present invention; and

FIG. 5 is a flowchart illustrating the steps of the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

The present invention modifies the chipset that acts as both CPU and video and audio decompression engine used in the DVD or other media player. The present invention provides a DVD player that looks, externally, just like a standard DVD player. However, the present invention provides an additional hardware-based decryption key that is serialized. Standard DVD discs can still be played on the DVD player of the present invention; however, specially encrypted DVD discs can only be played on a specific DVD player, namely, the DVD player that has the matching decryption key. DVD players manufactured in accordance with the present invention can recognize the presence or absence of the special encryption and decrypt the content as required. If the secret key for the DVD does not match the secret key in the DVD player, however, the information displayed on a television monitor will not be the intended programming.

Each chipset for each receiver has a unique decryption key. The secret key is programmed into the chip at the foundry level into secure, one-time programmable (OTP) circuitry. After the chip has been successfully programmed, the chip will be locked to prevent any further programming. The chip will also be packaged in such a way that the programming leads to that particular section of the ASIC will not be bonded out. In other words, if someone attempts to reprogram one of the chips, they will have to remove it from the packaging encapsulation, which is an extremely difficult process that usually results in destruction of the chip.

The secret decryption keys for each chipset are stored in a separate system, which also keeps track of the encryption keys. When an encrypted content DVD disc is needed, the encryption key for a given DVD player is accessed, and an encrypted DVD is generated and sent to the user of the matching DVD player.

Each chip can also have more than one decryption key. So, for example, there can be a “known” key or “public” key, that can be based on the serial number or other number associated with a given DVD player or DVD model number. This key can be used to track the DVD player, or for other purposes such as specific encryption of rental DVDs for that DVD model number, etc. The secret key, however, is not released to others, and is held by a third party for creation of specific DVD discs that will play on one and only one DVD player, namely, the DVD player that has the matching secret key decoder. As discussed herein, decoder and decrypter, as well as encoder and encrypter, are used interchangeably. Encoding and encryption can be considered equivalents, as are decoding and decryption.

Functional Flow

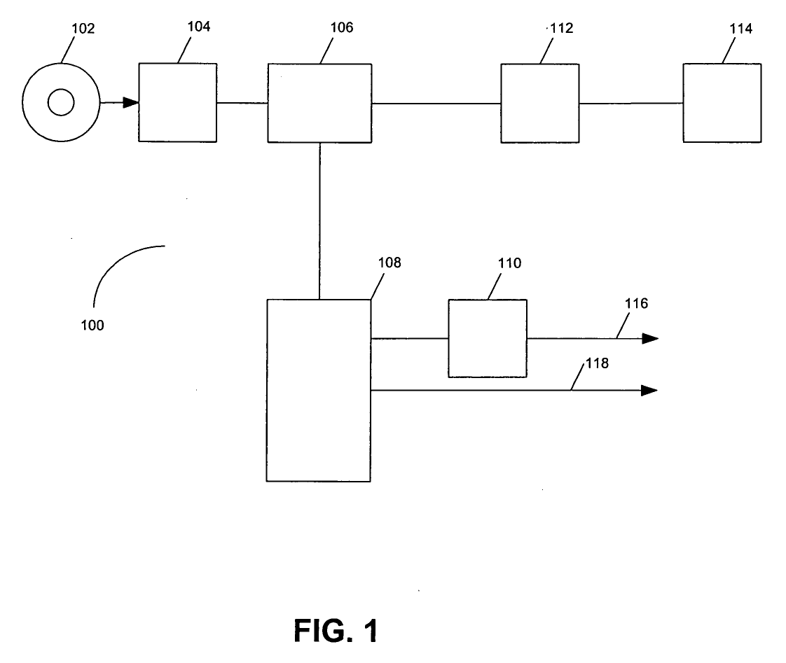

FIG. 1 illustrates a typical DVD player block diagram.

System 100 comprises disc 102, drive 104, front end Digital Signal Processor (DSP) 106, decoder 108, encrypter 110, Central Processing Unit (CPU) 112, and user interface 114.

Typical operation of system 100 comprises placing disc 102 into drive 104, which uses an optical or other reading mechanism to read the information contained on disc 102. This information is passed to DSP 106, which passes the video information to decoder 108 based on commands received from CPU 112.

Decoder 108 uses a decoding schema, typically MPEG-2 or MPEG-4 decoding, to decode the video and audio information that was passed from DSP 106. This information is then encoded using encrypter 110 to provide this information in a formatted signal 116, which can be used by a standard television monitor. Component video output 118 can also be provided. User interface 114 allows interaction with CPU 112, allowing for control of the drive 104 as well as selective control of the functionality within the DSP 106.

Any disc 102 can be played in any system 100, because all discs 102 are formatted similarly, and DSP 106 and decoder 108 are standardized across the industry. This creates problems for the industry because the outputs of system 100, namely formatted signal 116 and component video output 118, can be recorded by pirates or other people, or disc 102 can be copied directly on optical disc writers, and distributed outside of the desired distribution channels.

Key Decoder Serialization

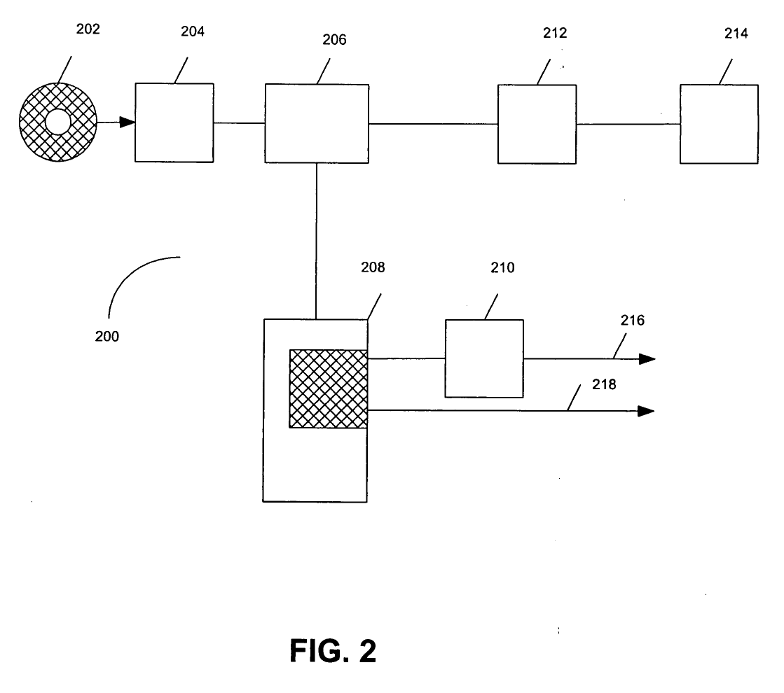

FIG. 2 illustrates a block diagram of a DVD system of the present invention.

System 200 comprises encoded disc 202, drive 204, front end DSP 206, serialized decoder 208, encrypter 210, CPU 212, and user interface 214.

Operation of system 200 comprises placing encoded disc 202 into drive 204, which uses an optical or other reading mechanism to read the information contained on encoded disc 202. This information is passed to DSP 206, which passes the video information to serialized decoder 208 based on commands received from CPU 212.

Serialized decoder 208 uses a decoding schema, typically MPEG-2 or MPEG-4 decoding, to decode the video and audio information that was passed from DSP 206. Serialized decoder 208 also uses another type of decoding, which is unique to a given media player, such that when the separate decoding schema is used, only encoded discs 206 that were encoded using a mating encoding key can be decoded by serialized decoder 208. Encoded discs 202 that are made with a different encoding key cannot be decoded properly by serialized decoder 208, and any signal that emanates from serialized decoder 208, e.g., formatted signal 216 or component output 218, will not be useable by the end user.

A disc 102 can also be played in any system 200, because all discs 102 are formatted similarly, and DSP 106 and decoder 108 are standardized across the industry. However, the present invention also allows for another level of encoding, which can be detected by system 200, that is transparent to the user. Any specially encoded disk 202 will play in the system 200 just as a normal disc 102. However, if the user tries to give encoded disc 202 to another person or play it on another system 100 or system 200, where the serialized encrypter 208 does not have a matching decoding key to that present on encoded disc 202, the encoded disc 202 will not be playable.

The present invention overcomes the problems associated with distribution of specialized discs to a limited number of people. An example of such a limited distribution is the distribution of films that are being considered for awards, such as Academy Awards® for various categories as best picture, best actor, etc. Another example is for studio screeners that use DVD-based programming to review for editing or other purposes. Such films are distributed on DVD to members of the Academy for Motion Picture Arts and Sciences (AMPAS) for viewing and voting purposes.

In the past, these sample DVD distributions have been copied or otherwise further distributed by the AMPAS members to the general public. As such, AMPAS has considered not releasing sample copies of the films, and requiring members to visit AMPAS facilities for viewing of the films. Similar limited distribution would be necessary for songs that are being considered for Grammy® awards, etc.

The present invention allows for delivery of the films via DVD to AMPAS members with further delivery of special DVD players that can play the specially encoded discs 202.

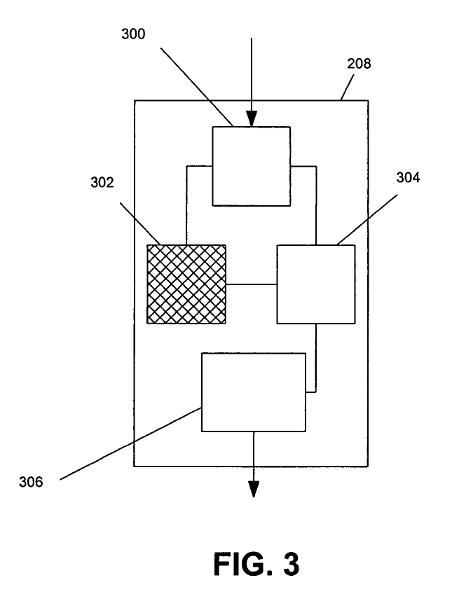

FIG. 3 illustrates an encrypter in accordance with the present invention.

Serialized decoder 208 typically comprises an input module 300, a serialized decoder 302, an MPEG decoder 304, and an output module 306.

In a typical DVD encrypter, the input module peforms frame or other pre-processing on the incoming signal, passes the pre-processed data to the decoder, which then decodes the data and passes the data to the output module for delivery to a component video output or other type of output, in various formats.

In the present invention, however, the input module can determine whether or not the data coming in from the disc 202 is specially encoded or is from a regular disc 102, and routes the pre-processed data to either the serialized decoder 302 or the MPEG decoder 304. The input module can, for example, read a header on the disc 202 to determine whether or not the disc 202 is specially encoded, and then route the pre-processed data accordingly. Other methods of determining whether or not the data is specially encoded are possible within the scope of the present invention.

If the disc is a normal disc 102, then the input module passes the data directly to MPEG decoder 304, which then passed the decoded data to output module 306. However, if the disc is an encoded disc 202, then the data is first sent to the serialized decoded 302, and then to the MPEG decoder 304, before being passed to the output module 306.

The present invention can also have the serialized decoder 302 after the MPEG decoder 304, so long as there is a way for the data to bypass the serialized decoder for discs 102 that are not specially encoded. Another system in accordance with the present invention contemplates that all discs 202 used in the system 200 must be specially encoded, and no regular discs 102 can be played in the system 200.

Manufacturing Flow

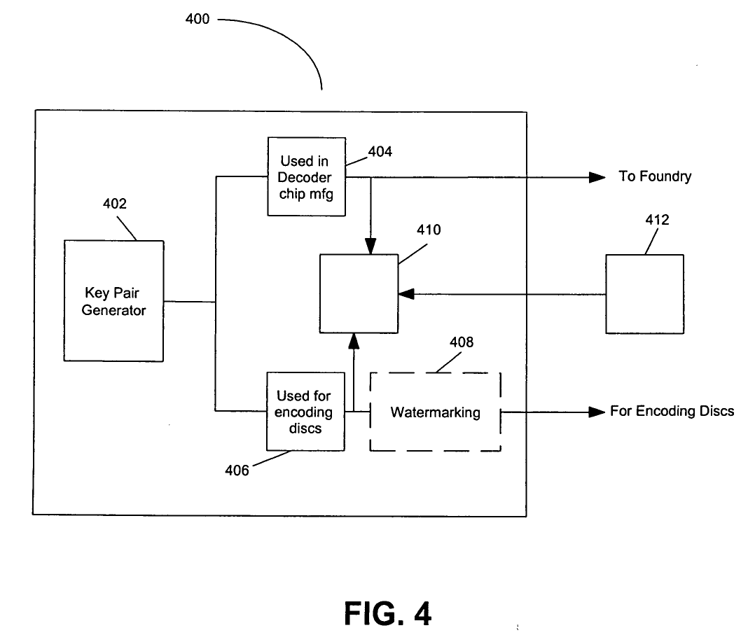

FIG. 4 illustrates a manufacturing flow in accordance with the present invention.

System 400 shows key pair generator 402, decoder key 404 path and encrypter key 406 path. Optional watermarking 408 is also shown.

System 400 generates a matched key set using generator 404. This matched set of keys will be applied to the encoding of special discs 202 and decoding those discs 202 in players with serialized decoders 208.

The decoder key 404 path sends the serialized decoder key to the decoder chip 208 foundry, where the decoder key is embedded into the decoder chip 208 at the foundry level. Each key is unique, and, thus, each decoder chip 208 will have a unique key associated with it. The mapping between each unique decoder key and each system 200 is stored in storage 410, for use when an encoded disc 202 is needed. This is a significant improvement over other types of security systems, especially software based solutions, since software based solutions typically have universal key sets covering the entire architecture. In previous systems 100, if someone does manage to break one of the key pairs, the entire system is subject to piracy.

In the present invention, if a key for a particular system 200 is extracted, that key cannot be used to decrypt content intended for other units, because that decoding key will not match any other encoding key generated by system 400. Further, because of the complexity of the decoding chip 208 ASIC, the process of extracting any single key would likely destroy the decoding chip 208 itself, and thus render the extracted key useless. Given this feature, DVD content can be uniquely encrypted such that it will only be viewable on a specific secure DVD player 200.

When an encoded disc 202 is needed, a distribution list 412 is given to the storage facility 410, which has a list of the decoder keys 404 and which systems 200 each of the serialized decoder keys 404 are resident in. The distribution list matches specific owners of systems 200 with each of the serialized decoder keys 404. For each of the decoder keys 404 listed on distribution list 412, the storage facility 410 uses the respective matching encrypter keys 406 to encode the desired distribution content onto encoded discs 202, and sends out the encoded discs to the recipients on the distribution list 412 by encrypter key 406 sorting. So, each recipient will receive a unique encoded disc 202, based on the decoder key 404 that is resident in that recipient's system 200, wherein the encoded disc 202 was encoded using an encrypter key 406 matched to that specific system 200.

Watermarking

The encoded discs 202 encrypted with a unique key 406 can be played on the DVD player with the matching decryption key 404. An additional security step can be taken on the encoded discs 202 and other discs 102 by using watermarking technology to further mark specific DVD discs to help forensic review and location of such DVD discs should pirated DVD discs appear.

When users of systems 200 know that a given disc 102 or 202 not only has specific encryption mated to their system 200, but each copy of such a disc 102 or 202 can be traced back to them, such knowledge provides a strong deterrent to those that may not otherwise wish to adhere to the content releasing parties' distribution limitations.

As such, the encoded disc 202 can optionally also have watermarking technology applied by watermarker 408, such that any copies of a given encoded disc 202 can be tracked to the source of the content in the unlikely event of an unauthorized distribution.

Additional Keys

Each serialized decoder chip 208 can have more than one decryption key. So, for example, there can be a “known” key or “public” key, that can be based on the serial number or other number associated with a given DVD player or DVD model number. This key can be used to track the DVD player, or for other purposes such as specific encryption of rental DVDs for that DVD model number, etc.

The secret key 404, however, is not released to others, and is held by a third party for creation of specific DVD discs that will play on one and only one DVD system 200 player, namely, the DVD player that has the matching secret key decoder 404 embedded in serialized decoder 208.

Distribution of Securely Encrypted DVDs

Masters of the DVDs will be provided to a third party by the releasing authority. The releasing authority will also provide distribution list 412 of the people to receive the DVD discs and the number of DVD discs each party is to receive.

The third party uses storage facility 410 and encoding keys 406 to produce and distribute the encoded discs 202 to the respective parties. Since the third party knows which party has a given DVD system 200 player, the third party can encrypt the DVD disc in such a manner that the DVD disc can only be played on the unit used/owned by that user. If someone else tries to play the DVD disc on another unit, the video and audio content on the encrypted DVD disc will not be successfully decrypted, and any picture or audio that is displayed on the monitor will be garbled or otherwise unuseable.

Flowchart

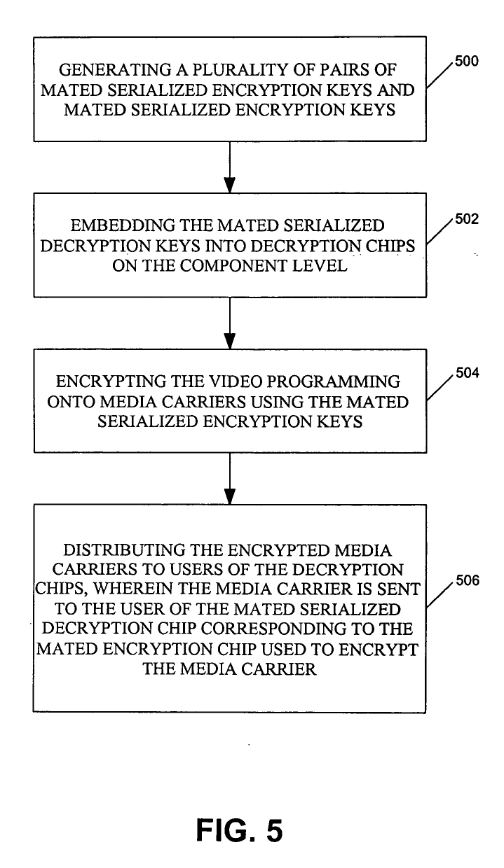

FIG. 5 is a flowchart illustrating the steps of the present invention.

Box 500 illustrates performing generating a plurality of pairs of mated serialized encryption keys and mated serialized decryption keys.

Box 502 illustrates performing embedding the mated serialized decryption keys into decryption chips on the component level.

Box 504 illustrates performing encrypting the video programming onto media carriers using the mated serialized encryption keys.

Box 506 illustrates performing distributing the encrypted media carriers to users of the decryption chips, wherein the media carrier is sent to the user of the mated serialized decryption chip corresponding to the mated encryption chip used to encrypt the media carrier.

### CONCLUSION

This concludes the description of the preferred embodiment of the invention. In summary, embodiments of the invention provide methods and apparatuses for increasing the security of video content in a limited distribution environment. A system in accordance with the present invention comprises an encrypted media carrier, encrypted using a first encryption key, and a media player, designed to receive the encrypted media carrier, the media player comprising a first decryption key stored in an decryption chip, wherein the first encryption key and the first decryption key are serialized, and the decryption key is entered into the media player at a component level, and the first encryption key is stored at a secure storage facility.

The system optionally further comprises a second encryption key and a second decryption key, wherein the second encryption key is accessible outside of the secure storage facility, a watermark applied to the encrypted media carrier, the first decryption key being stored in the decryption chip during manufacturing, the first decryption key being accessible only within the decryption chip, a distribution list which is used to distribute the encrypted media carrier, the encrypted media carrier being distributed based on a location of the media player having the first decryption key, the secure storage facility being operated by a third party, and the media player decrypting a media carrier that was not encrypted using the first encryption key.

A method in accordance with the present invention comprises generating a plurality of pairs of mated serialized encryption keys and mated serialized decryption keys, embedding the mated serialized decryption keys into decryption chips on the component level, encrypting the video programming onto media carriers using the mated serialized encryption keys, and distributing the encrypted media carriers to users of the decryption chips, wherein the media carrier is sent to the user of the mated serialized decryption chip corresponding to the mated encryption chip used to encrypt the media carrier.

The method optionally further comprises the mated serialized encryption keys and mated serialized decryption keys being stored at a secure storage facility, generating a second pair of encryption keys and decryption keys, embedding the second decryption key into at least one decryption chip on the component level, and allowing access to the second encryption key outside of the secure storage facility, applying a watermark to the video programming on the encrypted media carrier, the mated decryption key being stored in the decryption chip during manufacturing, the mated decryption key being accessible only within the decryption chip, the decryption keys being cross-referenced to users on a distribution list which is used to distribute the media carriers, the secure storage facility being operated by a third party, and media carriers that are not encrypted using the mated encryption key can be decrypted by the decryption chips.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto and the equivalents thereof.

What is claimed is:

1. A system for increasing the security of video content in a limited distribution environment, comprising:
an encrypted media carrier, encrypted using a first encryption key; and
a media player, designed to receive the encrypted media carrier, the media player comprising a first decryption key stored in an decryption chip;
wherein the first encryption key and the first decryption key are serialized, and the decryption key is entered into the media player at a component level, and the first encryption key is stored at a secure storage facility.

2. The system of claim 1, further comprising a second encryption key and a second decryption key, wherein the second encryption key is accessible outside of the secure storage facility.

3. The system of claim 2, further comprising a watermark applied to the encrypted media carrier.

4. The system of claim 3, wherein the first decryption key is stored in the decryption chip during manufacturing.

5. The system of claim 4, wherein the first decryption key is accessible only within the decryption chip.

6. The system of claim 5, further comprising a distribution list, which is used to distribute the encrypted media carrier.

7. The system of claim 6, wherein the encrypted media carrier is distributed based on a location of the media player having the first decryption key.

8. The system of claim 7, wherein the secure storage facility is operated by a third party.

9. The system of claim 8, wherein the media player can decrypt a media carrier that was not encrypted using the first encryption key.

10. A method for distributing video programming, comprising:
generating a plurality of pairs of mated serialized encryption keys and mated serialized decryption keys;
embedding the mated serialized decryption keys into decryption chips on the component level;
encrypting the video programming onto media carriers using the mated serialized encryption keys; and
distributing the encrypted media carriers to users of the decryption chips, wherein the media carrier is sent to the user of the mated serialized decryption chip corresponding to the mated encryption chip used to encrypt the media carrier.

11. The method of claim 10, wherein the mated serialized encryption keys and mated serialized decryption keys are stored at a secure storage facility.

12. The method of claim 11, further comprising generating a second pair of encryption keys and decryption keys, embedding the second decryption key into at least one decryption chip on the component level, and allowing access to the second encryption key outside of the secure storage facility.

13. The method of claim 12, further comprising applying a watermark to the video programming on the encrypted media carrier.

14. The method of claim 13, wherein the mated decryption key is stored in the decryption chip during manufacturing.

15. The method of claim 14, wherein the mated decryption key is accessible only within the decryption chip.

16. The method of claim 15, wherein the decryption keys are cross-referenced to users on a distribution list which is used to distribute the media carriers.

17. The method of claim 16, wherein the secure storage facility is operated by a third party.

18. The method of claim 17, wherein media carriers that are not encrypted using the mated encryption key can be decrypted by the decryption chips.
